(19) United States
(12) Patent Application Publication
(10) Pub. No.: US 2023/0112236 A1
(43) Pub. Date: Apr. 13, 2023

(54) SYSTEMS AND METHODS FOR GENERATING PREDICITIVE AND OPTIMIZED NEURAL NETWORKS

(71) Applicant: ARTIFICIALLY INTELLIGENT LLC, Thornton, CO (US)

(72) Inventor: Trevor E. Chandler, Thornton, CO (US)

(21) Appl. No.: 18/045,765

(22) Filed: Oct. 11, 2022

Related U.S. Application Data
(60) Provisional application No. 63/254,490, filed on Oct. 11, 2021.

(51) Int. Cl. G06N 3/04; G06K 9/62

(52) U.S. Cl. CPC G06N 3/0454; G06K 9/623

(57) ABSTRACT

An example method disclosed herein includes receiving data from a database, where the data is indicative of a first instance of the database, and where the data comprises a plurality of fields. The method further includes training a first neural network for a first data field, where the training is based at least in part on utilizing the plurality of data fields and determining a first interpretability score for each data field of the plurality of data fields used to train the first neural network, where each first interpretability score is indicative of a relevance for each data field of the plurality of data fields used to train the first neural network. The method further includes selecting a subset of data fields from the plurality of data fields used to train the first neural network, where the selection is based at least in part on the first interpretability score for each data field exceeding a first relevance threshold. The method further includes training a second neural network using the selected subset of data fields, where the second neural network is trained to provide predictions related to the first data field.

### CROSS-REFERENCE TO RELATED APPLICATIONS

This application is related to and claims the benefit of priority of U.S. Provisional Application No. 63/254,490 filed 11 Oct. 2021 and titled “SYSTEMS AND METHODS FOR GENERATING PREDICTIVE AND OPTIMIZED NEURAL NETWORKS,” which is hereby incorporated by reference in its entirety for all purposes.

### FIELD

Examples described herein generally relate to systems and methods for generating predictive and optimized neural networks.

### BACKGROUND

A neural network is a network (or circuit) of neurons. An artificial neural network is generally composed of artificial neurons (or nodes) used for finding solutions to artificial intelligence-based problems. In many cases, artificial neural networks are adaptive systems that can change structures based on, for example, external or internal information (e.g., labeled data, unlabeled data, etc.) that flows through the network. While the range of use cases for artificial networks is large, in specific instances, artificial neural networks are often used for predictive modeling, adaptive control, and applications where they can be trained via one or more datasets.

A common criticism associated with the training of artificial neural networks is that they often require a large amount of, and a large diversity of, training samples for valuable real-world operation. Such training requires time, money, and storage/memory resources that are often both compute resource- and cost-prohibitive. Even if the above-factors were non-issues, with large amounts of data comes the inability to know which data is valuable for training, and which is not. While artificial neural network research continues to advance, struggles and stagnation persist when it comes to generating optimized neural networks in the age of BigData.

### SUMMARY

An example method disclosed herein includes receiving data from a database, where the data is indicative of a first instance of the database, and where the data comprises a plurality of fields. The method further includes training a first neural network for a first data field, where the training is based at least in part on utilizing the plurality of data fields and determining a first interpretability score for each data field of the plurality of data fields used to train the first neural network, where each first interpretability score is indicative of a relevance for each data field of the plurality of data fields used to train the first neural network. The method further includes selecting a subset of data fields from the plurality of data fields used to train the first neural network, where the selection is based at least in part on the first interpretability score for each data field exceeding a first relevance threshold. The method further includes training a second neural network using the selected subset of data fields, where the second neural network is trained to provide predictions related to the first data field.

An example non-transitory computer readable medium disclosed herein includes instructions that, when executed by at least one processor of a computing system, cause the computing system to perform a method including receiving a first set of data from a first database and a second set of data from a second database, where the first set of data and the second set of data include at least one corresponding data field and locating matching data between the first set of data and the second set of data by comparing the corresponding data fields of the first set of data and the second set of data. The method further includes creating a combined data set from the first set of data and the second set of data by appending rows of data from the second set of data corresponding to the matching data to the first set of data, where the combined data set includes a plurality of data fields. The method further includes training a first neural network for a first data field of a plurality of data fields of the combined data set, where the training is based at least in part on utilizing the plurality of data fields. The method further includes selecting a subset of data fields from the plurality of data fields used to train the first neural network, based at least in part on determining a first interpretability score for each data field exceeding a first relevance threshold, where each first interpretability score is indicative of a relevance for each data field of the plurality of data fields used to train the first neural network and training a second neural network using the selected subset of data fields, where the second neural network is trained to provide predictions related to the first data field.

An example system disclosed herein includes a datastore including one or more instances of a database, where a first instance of the database is included in the one or more instances of the database, where the first instance of the database includes one or more data fields including row fields, column fields, or combinations thereof. The system further includes a computing device in communication with the datastore, where the computing device is configured to receive the first instance of the database and train a first network for a first data field, where the training is based at least in part on utilizing the one or more data fields. The computing device is further configured to determine a first interpretability score for each data field of the one or more data fields used to train the first neural network, where each first interpretability score is indicative of a relevance for each data field of the one or more data fields used to train the first neural network. The computing device is further configured to select a subset of data fields from the one or more data fields used to train the first neural network, where the selection is based at least in part on the first interpretability score for each data field exceeding a first relevance threshold and, based at least in part on the selected subset of data fields, train the first neural network, where the training includes iterating over one or more combinations of the subset of data fields. The computing system is further configured to determine a second interpretability score for each combination of the one of more of combinations of the subset of data fields, where each second interpretability score is indicative of a relevance for each combination of the one or more of combinations of the subset of data fields. The computing device is further configured to train a second neural network utilizing a selected combination of the one or more combinations, where the selection is based at least in part on the determined second interpretability scores. The system further includes a display, communicatively coupled to the computing device, where the display is configured to cause presentation of the first interpretability score, the second interpretability score, or combinations thereof.

### BRIEF DESCRIPTION OF THE DRAWINGS

Reference is now made to the following descriptions taken in conjunction with the accompanying drawings, in which:

FIG. 1 is a schematic illustration of a system for generating predictive and optimized neural networks, in accordance with examples described herein;

FIG. 2 is a schematic illustration of a system for generating predictive and optimized neural networks, in accordance with examples described herein;

FIG. 3 is a flowchart of a method for generating predictive and optimized neural networks, in accordance with examples described herein;

FIG. 4 is a flowchart of a method for generating predictive and optimized neural networks, in accordance with examples described herein;

FIG. 5 is a flowchart of a method for combining multiple data sets for generating predictive and optimized neural networks, in accordance with examples described herein;

FIG. 6 is an illustration of an interpretability chart, in accordance with examples described herein;

FIG. 7 is a schematic diagram of an example computing system, in accordance with examples described herein; and

FIG. 8 is an example user interface showing interpretability information, in accordance with examples described herein.

### SPECIFICATION

The present disclosure includes systems and methods for generating predictive and optimized neural networks.

In an example disclosed herein, a data store many comprise a database instance that includes a table containing data (e.g., data fields). The data fields and type of data may be varied based on the type of data to be analyzed. The table may include a number of data fields, including one or more row fields and/or one or more column fields. A first neural network may be trained to predict a specific one of the data fields, using the data fields in the table. Using an interpretability algorithm, it may be determined that a subset of the data fields are more relevant for training. The neural network may then be further trained on the subset of the data fields, and using an interpretability algorithm, the combination of subset of data fields most relevant to predicting the specific one of the data fields may be determined. A second neural network may be trained to predict the specific one of the data fields using the combination of the subset most relevant, and in some instances, may be tuned using parameters and hyperparameters. In some examples, when the database receives a query for the specific one of the data fields, systems and methods described herein may utilizing the second neural network when generating and output response.

As a more specific but non-limiting example, and in some instances, the database may include data fields comprising clinical trial data where the data fields may include patient information such as age, height, weights, gender, ethnicity, and the like. The clinical trial data may further include additional information such as medications taken, dosage amount, duration of time medication has been taken, time increments for when each medication is administered, and the like. In all, the clinical trial data may include multiple data fields (e.g., data columns), such as between 2 to 50 and in some instances may include 15 data fields. Although, it can be appreciated the number of data fields may be varied based on the desired applications, data to be analyzed and the like.

It should be noted that in some examples, the systems and methods described herein may be configured to predict multiple, if not all, the data fields in a database. In many instances, such as where every data field may be desired to be predicted, the system can generate a predictive layer that can predict each data field within the database. However, in other implementations, such as where only a subset or portion of the data fields may be desired to be predicted, the system may be configured to predict a portion of the data fields. As such, the discussion of any particular number of set of data fields to be predicted is meant as illustrative only.

The system may predict a portion of the data fields, in some examples, by automatically training a neural network for each data field where the system has detected a relationship between the data field and a prediction target. For example, the system may be configured to automatically train neural networks for each data field having an interpretability score (or other type of score) greater than one. In some examples, the system may allow a user to choose (e.g., via a user interface) which data fields to train neural networks for. In such examples, the user may be provided with information (such as an interpretability score for each data field) about the relationships of data fields to a prediction target before choosing how many or which neural networks to train. Accordingly, a user may choose a threshold interpretability score and/or a number of neural networks to train. In some examples, the system may further notify a user (e.g., via a user interface) that no relationships exist between the provided data fields and a prediction target. In such examples, the system may save resources (e.g., time, processing resources, and/or memory resources) by not training neural networks which will not be able to make accurate predictions.

A computing device may receive the database instance containing the patient information. The computing device may iteratively train 15 different neural networks, where each neural network as trained for a particular one of the 15 data fields. In some examples, the neural network is initially, iteratively trained using all of the data fields.

For a first neural network trained to predict patient age using all of the data fields, the computing device may run an interpretability algorithm to determine which data fields are more significant (e.g., more relevant) to predicting patent age based on interpretability scores obtained from the interpretability algorithm. In some examples, the computing device may then cycle through the remaining significant (e.g., relevant) data fields, where the remaining data fields are, in some examples, relationally grouped (e.g., by height, weight, time, medication information, etc.). The computing device may run a second interpretability algorithm to determine with pairing or grouping of the remaining data fields that produced the most optimized trained neural network for predicting age (e.g., highest interpretability score, etc.). A display may present to a user of the computing device the results of the interpretability analysis.

In some examples, using the pairing or grouping of the remaining data fields having the highest interpretability score, another neural network may be trained to predict age. Here, parameters, hyperparameters, and the like may be used to tune and fine-tune this neural network. In some instances parameters based on category and type may be used. In some examples, a user of a user device may then query the database with questions regarding patient age. In some examples, the query may use Boolean logic. In some examples, an predictive output may be returned in response to the Boolean logic query, where the predictive outcome is based at least in part of using the another neural network trained using the remaining data fields having the highest interpretability score and tuned and/or fine-tuned using the parameters and hyperparameters.

Techniques described herein include a neural network training system for generating predictive and optimized neural networks. In some instances, the system may include a database, a computing device including memory comprising executable instructions for training and optimizing neural networks, and one or more user devices. Further the system may utilize and/or analyze data stored in a variety of locations (e.g., a cloud storage location accessible by the system) and data stored using a variety of data types (e.g., XML files, SQL server databases, and the like).

The database (e.g., data store, etc.) may comprise one or more instances of a database, including, in some examples, a first instance of a database, a second instance of a database, and so forth. In some examples, the first instance of the database may be included in the one or more instances of the database. In some examples, the first instance of the database may comprise one or more data fields including row fields, column fields, or combinations thereof. In some examples, the system may automatically detect various data sources accessible by the system. In some examples, the data fields may further comprise duration information, date information, or combinations thereof. In some instances, the duration information may comprise time stamp information, time interval length information, duration length information, or combinations thereof. In some instances, the date information comprises day information, month information, year information, or combinations thereof.

The computing device may be in communication with and/or communicatively coupled to the database and/or the one or more user devices, and may be configured to perform a number of actions for generating predictive and optimized neural networks. In some examples, the computing device may be configured to receive the first instance of the database. In some examples, the computing device may be configured to iteratively train a first neural network for a first data field, where the training is based at least in part on utilizing the one or more of data fields. As should be appreciated, and as used herein, a neural network is meant to encompass machine-learning, artificial intelligence, and other related technologies In some examples, the computing device may be configured to determine a first interpretability score for each data field of the one or more of data fields used to train the first neural network, wherein each first interpretability score is indicative of a relevance for each data field of the one or more data fields used to train the first neural network.

In some examples, the computing device may be configured to select a subset of data fields from the one or more data fields used to train the first neural network, the selection based at least in part on the first interpretability score for each data field exceeding a first relevance threshold. In some examples, the computing device may be configured to, based at least in part on the selected subset of data fields, iteratively train the first neural network, wherein the training comprises iterating over one or more combinations of the subset of data fields. In some examples, the computing device may be configured to determine a second interpretability score for each combination of the one or more of combinations of the subset of data fields, wherein each second interpretability score is indicative of a relevance for each combination of the one or more of combinations of the subset of data fields. In some examples, the computing device may be configured to iteratively train a second neural network utilizing a selected combination of the one or more of combinations, the selection based at least in part on the determined second interpretability scores.

The display device may be communicatively coupled to the computing device and the database, and may be configured to cause presentation of the first interpretability score, the second interpretability score, or combinations thereof. In various examples, the system may generate different types outputs to be displayed to a user via the display device. One or more of the types of outputs may be displayed to the user. For example, the system may provide reports on every possible predictable target in a dataset, an interpretability scores for other data fields of the data set relative to each of the targets. Further the system may provide to the user an indication that the system has trained a set of neural networks automatically trained based on relationships between the data. In various examples, a user interface at the display device may further allow a user to export, download, or otherwise access such neural networks (e.g., source code for the networks) for use in other applications.

In this way, the various methods and systems described herein allow the neural networks to more accurately predict outputs, without biasing the systems towards a particular parameter as controlling. In other words, the systems described herein can more accurately provide predications on a range of issues and questions, this allows all data within a database to be predicted based at least in part on the predictive and optimized neural networks, as compared to conventional systems that may only be able to predict one type of data, e.g., one data field or may be skewed in generating a predictive result based on human entered controlling values. This allows for more accurate predications as compared to conventional systems.

Further, training neural networks may be time and resource intensive, such that it is not desirable to train neural networks with data that is ineffective in training the networks. For example, providing ineffective data to a neural network for training may still use time and processing resources, while providing no additional benefit in terms of accuracy of the neural network. Accordingly, understanding what types of data are effective in training neural networks may result in more efficient training of such neural networks.

The methods and systems described herein provide increased understanding of relationships between data, as well as automatically training a neural network for each relationship found in the data. Such training for each relationship may result in a complete predictive layer covering all relationships within data across one or many data repositories.

The methods and systems described herein may provide additional advantages when using multiple datasets. For example, multiple datasets may be linked together using matching columns of data, which may enable the system to identify relationships between data points in two different datasets. Accordingly, the system may identify relationships across datasets and train neural networks with all data across multiple datasets having such relationships.

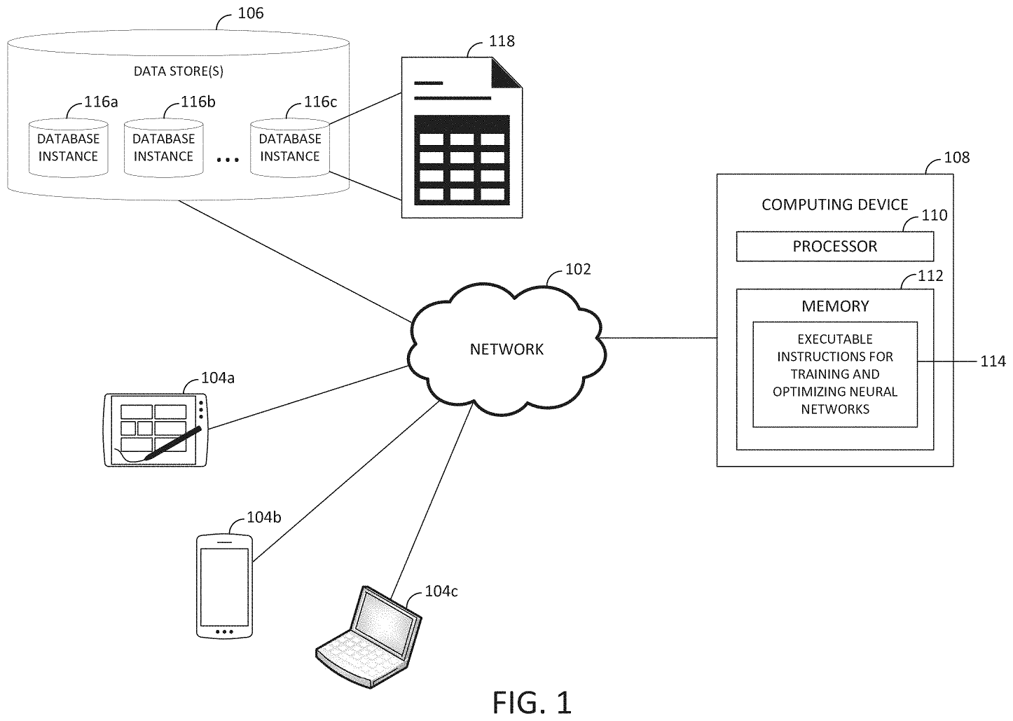

Turing to the figures, FIG. 1 is a schematic illustration of a system 100 for generating predictive and optimized neural networks, in accordance with examples described herein. It should be understood that this and other arrangements and elements (e.g., machines, interfaces, function, orders, and groupings of functions, etc.) can be used in addition to or instead of those shown, and some elements may be omitted altogether. Further, many of the elements described herein are functional entities that may be implemented as discrete or disturbed components or in conjunction with other components, and in any suitable combination and location. Various functions described herein as being performed by one or more components may be carried out by firmware, hardware, and/or software. For instance, and as described herein, various functions may be carried out by a processor executing instructions stored in memory.

System 100 of FIG. 1 includes user devices 104a-104c, data store 106 (e.g., a non-transitory storage medium), and computing device 108. Computing device 108 includes processor 110, and memory 112. Memory 112 includes executable instructions for training and optimizing neural networks 114. It should be understood that system 100 shown in FIG. 1 is an example of one suitable architecture for implementing certain aspects of the present disclosure. Additional, fewer, and/or alternative components may be used in other examples.

It should be noted that implementations of the present disclosure are equally applicable to other types of devices such as mobile computing devices and devices accepting gesture, touch, and/or voice input. Any and all such variations, and any combinations thereof, are contemplated to be within the scope of implementations of the present disclosure. Further, although illustrated as separate components of computing device 108, any number of components can be used to perform the functionality described herein. Although illustrated as being a part of computing device 108, the components can be distributed via any number of devices. For example, processor 110 may be provided by one device, server, or cluster of servers, while memory 112 may be provided via another device, server, or cluster of servers.

As shown in FIG. 1, computing device 108, and user devices 104a-104c may communicate with each other via network 102, which may include, without limitation, one or more local area networks (LANs), wide area networks (WANs), cellular communications or mobile communications networks, Wi-Fi networks, and/or BLUETOOTH® networks. Such networking environments are commonplace in offices, enterprise-wide computer networks, laboratories, homes, intranets, and the Internet. Accordingly, network 102 is not further described herein. It should be understood that any number of computing devices, data stores, and/or user devices may be employed within system 100 within the scope of implementations of the present disclosure. Each may comprise a single device or multiple devices cooperating in a distributed environment. For instance, computing device 108 could be provided by multiple server devices collectively providing the functionality of computing device 108 as described herein. Additionally, other components not shown may also be included within the network environment.

Computing device 108 and user devices 104a-104c may have access (via network 102) to at least one data store repository, such as data store 106. Data store 106 may comprises one or more instances of a database, such as database instances 116a-116c. In some examples, database instances described herein may include data fields contained in various file types, containers, collections of data, and the like, including tables, charts, graphs, and any other holding place for data whether in a file, in a tag, in a database, described in code, etc. For example, database instance 116c may comprise table 118 that may comprise data fields, including row fields, column fields, and other type of data field. As should be appreciated, while only several data fields are discussed herein, other data fields are contemplated to be within the scope of this disclosure.

Data store 106, including in some examples database instances 116a-116c, may further store data and metadata associated with generating predictive and optimized neural networks, including but not limited to data and metadata associated with training and optimizing neural networks. For example, data store 106, including in some examples database instances 116a-116c, data fields such as row fields, column fields, other types of data fields, and the like, used in some examples, to train neural networks described herein. In some examples, the data fields may further comprise duration information, date information, or combinations thereof. In some instances, the duration information may comprise time stamp information, time interval length information, duration length information, or combinations thereof. In some instances, the date information comprises day information, month information, year information, or combinations thereof. As should be appreciated, while database instance 116c is illustrated as comprising table 118 that comprises row fields and column fields, database instance 116c (and other database instances of data store 106) may comprise additional and/or alternative data field types.

Database instances 116a-116c may include, in various examples, data collected from third-party sources, including data retrieved from other data stores, such as through database queries, through a network (e.g., network 102). Data store 106 may, in various examples, include data from multiple third-party sources. As one non-limiting example, data store 106 may store data and or metadata related to digital health records, stock market information, weather information, sports statistics, academic grades, and the like. In some examples, digital health records, stock market information, weather information, sports statistics, academic grades, and the like, may be relationally grouped in a number of ways, including but not limited to event type, time, date, result, and the like, in entities such as tables, pairings, and the like, as described herein.

Data store 106 may further store data and metadata associated with parameter information and/or hyperparameter information. In some examples, the parameter information and/or the hyperparameter information may be used to tune, fine tune, and the like, neural networks, such as the neural networks described herein. In some examples, data store 106 may store parameter information including layer parameter information. In some examples, layer parameter information may include but is not limited to layer size parameters (e.g., number of neurons, etc.) and layer type parameters. In some examples, parameter information may further comprise data and metadata associated with numerical parameters, categorical parameters, or combinations thereof. In some examples, data store 106 may store further hyperparameter information including one or more of a learning rate, a batch size, a number of epochs, a momentum, a regularization coefficient, or combinations thereof. As should be appreciated, while only several parameters and hyperparameters are discussed herein, other parameters and hyperparameters capable of tuning and fine tuning neural networks are contemplated to be within the scope of this disclosure.

Data store 106, including in some examples database instances 116a-116c, may further store data and metadata associated with interpretability algorithms, such as a shapley additive explanations (SHAP) algorithm, partial dependence plot (PDP) algorithm, an individual conditional expectation (ICE) algorithm, a permuted feature importance (PFI) algorithm, a global surrogate algorithm, a local surrogate (LIME) algorithm, or combinations thereof. In some examples, data store 106, including in some examples database instances 116a-116c, may further store data and metadata associated with interpretability scores (and/or charts, graphs, reports, and the like). In some examples, the interpretability scores may each be indicative of a relevance for each data field of a plurality of data fields used to train neural networks described herein. As should be appreciated, while only several interpretability algorithms are discussed herein, other interpretability algorithms are contemplated to be within the scope of this disclosure.

Data store 106, including in some examples database instances 116a-116c, may further store data and metadata associated with one or more neural networks. In some examples, the neural networks may be trained, and in some examples, the neural networks may be untrained. In some examples, data store 106 may store data and metadata associated with both trained and untrained neural networks.

In implementations of the present disclosure, data store 106 is configured to be searchable for the data and metadata stored in data store 106. It should be understood that the information stored in data store 106 may include any information relevant to generating predictive and optimized neural networks, such as iteratively training a first neural network using all data fields in a database instance, determining interpretability scores for the data fields used to train the first neural network, iteratively training the first neural network using a subset of the data fields based at least on the interpretability scores, determining another interpretability score for each combination of data fields in the selected subset of data fields, and iteratively training a second (or other) neural network based on the second interpretability scores.

Such information stored in data store 106 may be accessible to any component of system 100. The content and the volume of such information are not intended to limit the scope of aspects of the present technology in any way. Further, data store 106 may be a single, independent component (as shown) or a plurality of storage devices, for instance, a database cluster, portions of which may reside in association with computing device 108, sampling user devices 104a-104c, another external computing device (not shown), another external user device (not shown), and/or any combination thereof. Additionally, data store 106 may include a plurality of unrelated data repositories or sources within the scope of embodiments of the present technology. Data store 106 may be updated at any time, including an increase and/or decrease in the amount and/or types of stored data and metadata.

Examples described herein may include user devices, such as user devices 104a-104c. User devices 104a-104c may be communicatively coupled to various components of system 100 of FIG. 1, such as, for example, computing device 108. User devices 104a-104c may include any number of computing devices, including a head mounted display (HMD) or other form of AR/VR headset, a controller, a tablet, a mobile phone, a wireless PDA, touchless-enabled device, other wireless (or wired) communication device, or any other device capable of executing machine-language instructions. Examples of user devices 104a-104c described herein may generally include a display, such as those described herein. In some examples, a display of a user device, such as user devices 104a-104c may generally be configured to cause presentation of the first interpretability score, the second interpretability score, and/or additional and/or alternative interpretability scores, reports, graphs, and the like. In some examples, a display of a user device, such as user devices 104a-104c may generally be configured to present information associated with training neural networks, generating predictive and optimized neural networks, and the like.

In some examples, a user of a user device, such as user devices 104a-104c may use the presented information to better understand certain relationships between data fields and neural network training that may not have been previously known. In some examples, user devices 104a-104c may present a graphical user interface of a data store, such as data store 106 and/or a graphical user interface that provides access to one or more of the trained neural networks described herein. In some examples, user devices 104a-104c may present a graphical user interface (to a user, for example) of a searchable data store, wherein the data store is search able via a Boolean logic query. In some examples, user devices 104a-104c may return an output to such Boolean (and or other) logic query, based at least in part on using the trained neural networks described herein.

Examples described herein may include computing devices, such as computing device 108 of FIG. 1. Computing device 108 may in some examples be integrated with one or more user devices, such as user devices 104a-104c, described herein. In some examples, computing device 108 may be implemented using one or more computers, servers, smart phones, smart devices, tables, and the like. Computing device 108 may implement generating predictive and optimized neural networks. As described herein, computing device 108 includes processor 110 and memory 112. Memory 112 includes executable instructions for training and optimizing neural networks 114, which may be used to generate predictive and optimized neural networks. In some embodiments, computing device 108 may be physically coupled to user devices 104a-104c. In other embodiments, computing device 108 may not be physically coupled to user devices 104a-104c but collocated with the user devices. In even further embodiments, computing device 108 may neither be physically coupled to user devices 104a-104c nor collocated with the user devices 104a-104c.

Computing devices, such as computing device 108 described herein may include one or more processors, such as processor 112. Any kind and/or number of processor may be present, including one or more central processing unit(s) (CPUs), graphics processing units (GPUs), other computer processors, mobile processors, digital signal processors (DSPs), microprocessors, computer chips, and/or processing units configured to execute machine-language instructions and process data, such as executable instructions for training and optimizing neural networks 114.

Computing devices, such as computing device 108, described herein may further include memory 112. Any type or kind of memory may be present (e.g., read only memory (ROM), random access memory (RAM), solid-state drive (SSD), and secure digital card (SD card)). While a single box is depicted as memory 112, any number of memory devices may be present. Memory 112 may be in communication (e.g., electrically connected) with processor 110.

Memory 112 may store executable instructions for execution by the processor 110, such as executable instructions for training and optimizing neural networks 114. Processor 110, being communicatively coupled to user devices 104a-104c, and via the execution of executable instructions for training and optimizing neural networks 114, may generate predictive and optimized neural networks.

In operation, to generate predictive and optimized neural networks, processor 110 of computing device 108 may execute executable instructions for training and optimizing neural networks 114 to receive data from a database, such as data store 106, where, in some examples, the received data may be indicative of a first instance of the database, such as database instance 116a. In some examples, the data received from the data store may comprise a plurality of data fields. As described herein, in some examples, the data fields may comprise one or more row fields, one or more column fields, or combinations thereof. In some examples, the data fields may further comprise duration information, date information, or combinations thereof. In some examples, the duration information may comprise time stamp information, time interval length information, duration length information, or combinations thereof. In some examples, the date information may comprise day information, month information, year information, or combinations thereof. In some examples, the first instance of the database may comprise at least one data table comprising the plurality of data fields. As should be appreciated, while data tables are discussed herein, any type of holding place (e.g., container, file, tag, code, etc.) for data is contemplated to be within the scope of this disclosure, and discussion of data tables is in no way limiting.

Processor 110 of computing device 108 may further execute executable instructions for training and optimizing neural networks 114 to train a first neural network for a first data field, where the training of the first neural network is based at least in part on utilizing the plurality of data fields. In some examples, the executable instructions may be instructions to iteratively train the first neural network for the first data field.

Processor 110 of computing device 108 may execute executable instructions for training and optimizing neural networks 114 to, determine a first interpretability score for each data field of the plurality of data fields used to train the first neural network. In some examples, each first interpretability score may be indicative of a relevance for each data field of the plurality of data fields used to train the first neural network. In some instances, determining the first interpretability score for each data field of the plurality of data fields used to train the first neural network may be based at least in part on utilizing an interpretability algorithm. In some examples, various interpretability algorithms may be implemented. For example, in some instances, the interpretability algorithm may comprise a shapley additive explanations (SHAP) algorithm, partial dependence plot (PDP) algorithm, an individual conditional expectation (ICE) algorithm, a permuted feature importance (PFI) algorithm, a global surrogate algorithm, a local surrogate (LIME) algorithm, or combinations thereof. In some examples, other interpretability algorithms not described but capable of generating a relevant outcome for one or more of the data fields may be used. In some examples, each first interpretability score determined for each data field of the plurality of data fields used to train the first neural network may be indicative of the relevance for each data field of the plurality of data fields used to train the first neural network. As should be appreciated, while interpretability algorithms are discussed herein, other methods may be used. For example, the internal structure of components of system 100 may be interrogated by computing device 108 (or other component(s) of system 100, or other components not shown) to determine the effectiveness (and/or impact, etc.) of the data fields towards predicting outcomes of the trained neural networks. In this way, while interpretability algorithms may be used, other methods for determining effectiveness of the data fields towards predicting outcomes are contemplated to be within the scope of this disclosure.

In some examples, processor 110 of computing device 108 may execute executable instructions for training and optimizing neural networks 114 to select a subset of data fields from the plurality of data fields used to train the first neural network. In some examples, the selection may be based at least in part on the first interpretability score for each data field exceeding a first relevance threshold.

In some examples, processor 110 of computing device 108 may execute executable instructions for training and optimizing neural networks 114 to, based at least in part on the selected subset of data fields, train the first neural network, where, in some examples, the training may comprise iterating over a plurality of combinations of the subset of data fields. In some examples, training may instead include training using each of the subset of data fields, without iterating over the plurality of combinations of the subset of data fields. For example, a neural network may be provided with labeled data from each of the subset of data fields as training data. In some examples, iteratively training the second neural network may be further be based at least in part on utilizing parameters, hyperparameters, or combinations thereof, as described herein. In some instances, the parameters may comprise at least layer parameters, comprising a layer size parameter, a layer type parameter, or combinations thereof. In some instances, the layer size parameter may correspond to a number of neurons in a layer. In examples, the hyperparameters may comprise at least a learning rate, a batch size, a number of epochs, a momentum, a regularization coefficient, or combinations thereof. In some instances, the parameters may comprise numerical parameters, categorical parameters, or combinations thereof.

In some examples, processor 110 of computing device 108 may execute executable instructions for training and optimizing neural networks 114 to determine a second interpretability score for each combination of the plurality of combinations of the subset of data fields. In some examples, each second interpretability score may be indicative of a relevance for each combination of the plurality of combinations of the subset of data fields. In some examples, determining the second interpretability score for each combination of the plurality of combinations of the subset of data may be based at least in part on utilizing an interpretability algorithm, such as the interpretability algorithms described herein.

In particular, and in some instances, the interpretability algorithm may be a shapley additive explanations (SHAP) algorithm, partial dependence plot (PDP) algorithm, an individual conditional expectation (ICE) algorithm, a permuted feature importance (PFI) algorithm, a global surrogate algorithm, a local surrogate (LIME) algorithm, or combinations thereof. In some instances, each (or some of, or one or more of the) second interpretability score determined for combination of the plurality of combinations of the subset of data may be indicative of the relevance for each combination of the plurality of combinations of the subset of data fields.

In some examples, processor 110 of computing device 108 may execute executable instructions for training and optimizing neural networks 114 to train a plurality of neural networks, including the first neural network. In some instances, where the plurality of neural networks are trained iteratively, the plurality of neural networks trained corresponds to the plurality of data fields. As one example, if the number of data fields (e.g., column fields) equals 10, then the number of neural networks trained would be 10, such that one each neural network trained corresponds to one of the data fields (e.g., one of the column fields). In this way, systems and methods described herein, in some examples, iterate over all of the data fields in a database instance, such as database instance 116a. As should be appreciated, in some examples, systems and methods described herein iterate over all of the data fields in a data store, such as data store 106. As such, systems and methods described herein, in some examples, generate a complete prediction layer. In some examples, the data fields utilized for the iterative training of neural networks described herein may be relationally paired, grouped, and the like by various criteria. In some examples, the data fields may be grouped by column field, by row field, by event, by percentages, by time, by date, and the like.

In some examples, processor 110 of computing device 108 may execute executable instructions for training and optimizing neural networks 114 to train a plurality of neural networks, including the first neural network. In some examples, the plurality of neural networks trained may correspond to the plurality of data fields.

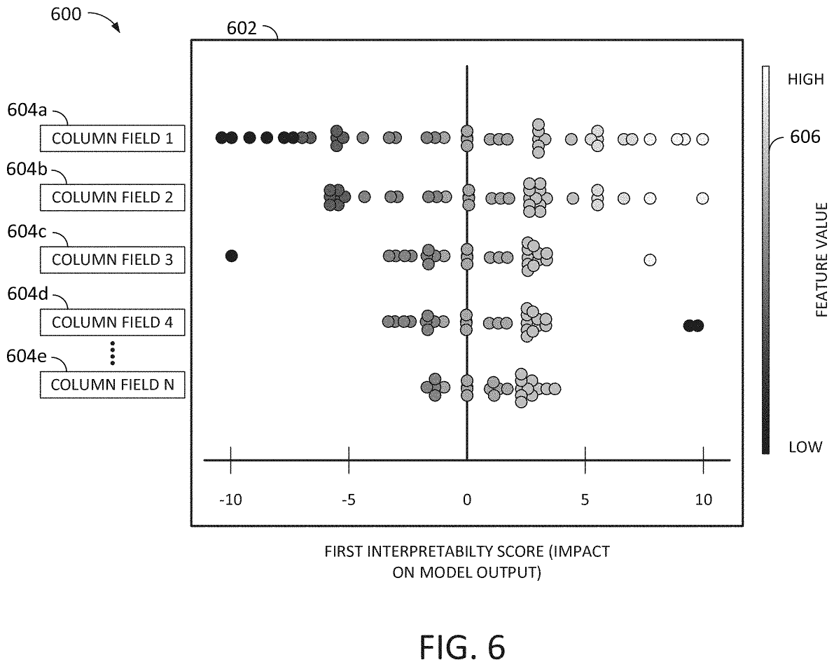

In some examples, processor 110 of computing device 108 may execute executable instructions for training and optimizing neural networks 114 to cause presentation of the first interpretability score, the second interpretability score, or combinations thereof on a display devise as described herein, such as display 606 of FIG. 6.

In some examples, processor 110 of computing device 108 may execute executable instructions for training and optimizing neural networks 114 to receive, at the first instance of the database, an input query regarding the plurality of data fields. In some examples, the query may be written using Boolean logic. As should be appreciated, while Boolean logic queries are described herein, other queries are contemplated to be within the scope of this disclosure. In some instances, based at least in part on receiving the query, second trained neural network may be utilized to determine and transmit an output answer. In this way, systems and methods described herein may provide for searchable database using predictive and optimized neural networks.

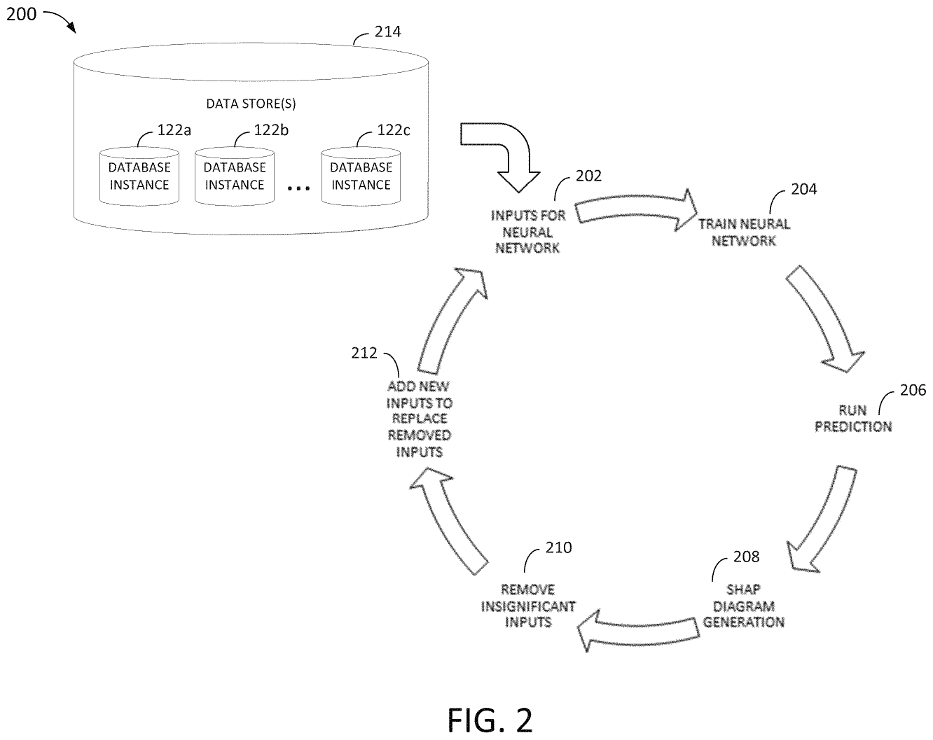

Turing now to FIG. 2, FIG. 2 is a schematic illustration of a system 200 for generating predictive and optimized neural networks, in accordance with examples described herein. System 200 includes data store 214 and database instances 122a-122c. In some examples, and while not shown, a computing device, such as computing device 108 of FIG. 1, may receive data fields from data store 214. In some examples, those data fields may be used by computing device 108 as inputs for neural network 202. Computing device 106 may then train the first neural network at 204 using the inputs 202. Computing device 106 may then run a prediction for one of the data fields at 208. Computing device 108 may then, and as described herein, run an interpretability algorithm on the data fields used (e.g., inputs for neural network 202). In some examples, the interpretability algorithm may be a SHAP algorithm, which may, in some examples, generate a SHAP diagram 208. In some examples, computing device 108 may remove insignificant inputs 210 (e.g., data fields with a low relevance score, inputs that fail to meet and/or in some examples exceed a relevancy threshold, etc.). In some examples, new inputs are added to replace the removed inputs 212. In some examples, the data fields with the highest interpretability scores and/or those with interpretability scores over a specified threshold (e.g., greater than 0), may be retained and used to train a second neural network, which may be used to generate predictions. In some examples, the first neural network may be re-trained using the data fields with the highest interpretability scores.

In some examples, and also at 212, based at least in part on the selected subset of data fields, computing device 108 may iteratively train the first neural network, wherein the training comprises iterating over a plurality of combinations of the subset of data fields. In some examples, and also at 212, combinations of significant (e.g., relevant) inputs may be cycled to find (e.g., determine) the most effective combination of inputs to train the optimized neural network with. The determined effective combination of inputs may then be, in some examples, used to train a second neural network, where the second neural network may be used to generate predictions.

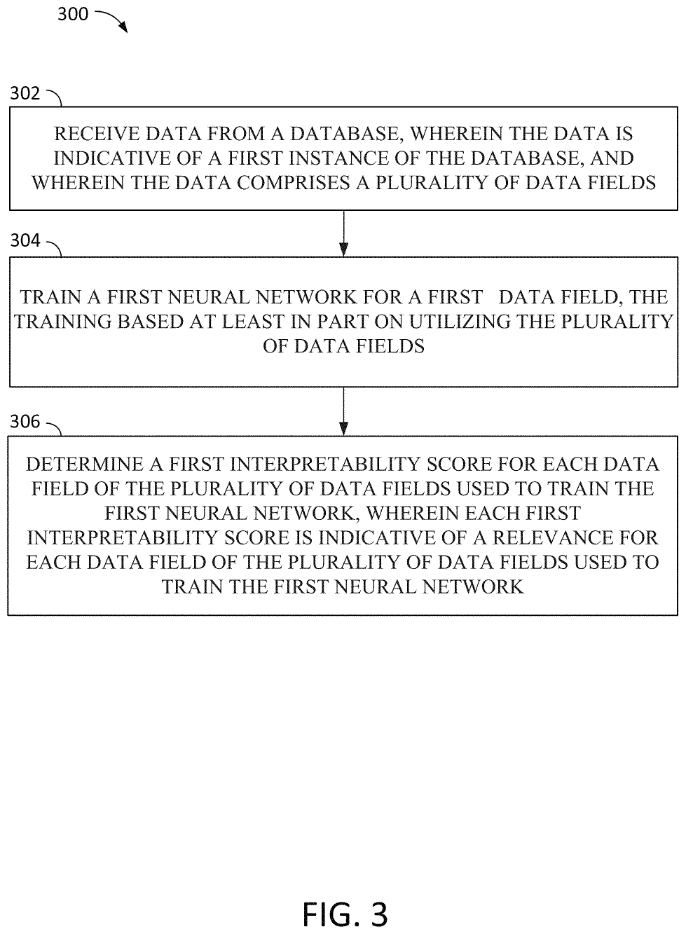

Now turning to FIG. 3, FIG. 3 is a flowchart of a method 300 for generating predictive and optimized neural networks, in accordance with examples described herein. The method 300 may be implemented, for example, using the system 100 of FIG. 1.

The method 300 includes receiving data from a database, wherein the data is indicative of a first instance of the database, and wherein the data comprises a plurality of data fields in step 302; iteratively training a first neural network for a first data field, the training based at least in part on utilizing the plurality of data fields in step 304; and, determining a first interpretability score for each data field of the plurality of data fields used to train the first neural network, wherein each first interpretability score is indicative of a relevance for each data field of the plurality of data fields used to train the first neural network in step 306.

Step 302 includes receiving data from a database, wherein the data is indicative of a first instance of the database, and wherein the data comprises a plurality of data fields. As described herein, in some examples, data fields may include by are not limited to row fields, column fields, other types of data fields, and the like. In some examples, data fields may further comprise duration information, date information, or combinations thereof. In some instances, the duration information may comprise time stamp information, time interval length information, duration length information, or combinations thereof. In some instances, the date information comprises day information, month information, year information, or combinations thereof.

In various examples, the received data may include a first data field used to train the first neural network. For example, the first data field may be a binary data field, and the remainder of the data fields in the data may be evaluated for their predictive strength of the binary data field. Further, the first neural network may be trained to predict the value of the binary data field based on values of one or more of the other data fields of the data. For example, the binary data field may be diabetic status of a subject. Other data fields may be various data about the subject, which may or may not be predictive of whether the subject has or does not have diabetes. For example, other data fields may include glucose readings, blood pressure, BMI, age, ZIP code, number of pregnancies, cholesterol readings, and the like. The method 300 may generally determine which of the data fields are relevant to the prediction of diabetic status and may train the first neural network using the relevant data fields and the binary data field. In various examples, the first data field may be data other than a binary data field. For example, the first data field may be a numeric data field and the first neural network may be trained to predict the value of the first data field in a similar manner.

Step 304 includes training a first neural network for a first data field, the training based at least in part on utilizing the plurality of data fields. For example, the first neural network may be provided with each of the data fields received at step 302, such that the trained first neural network may be trained to predict a value or values for the first data field based on provided values for one or more of the plurality of data fields. In various examples, such training may be completed using an optimization algorithm to map the inputs (e.g., the plurality of data fields not including the first data field) to the output (e.g., the first data field). In some examples, step 304 may include iteratively training the first neural network. That is, the training may iterate over a plurality of combinations of the plurality of data fields received at step 302 to train the first neural network.

Step 306 includes determining a first interpretability score for each data field of the plurality of data fields used to train the first neural network, wherein each first interpretability score is indicative of a relevance for each data field of the plurality of data fields used to train the first neural network. As described herein, in some examples, each first interpretability score may be indicative of a relevance for each data field of the plurality of data fields used to train the first neural network. In some instances, determining the first interpretability score for each data field of the plurality of data fields used to train the first neural network may be based at least in part on utilizing an interpretability algorithm. In some examples, various interpretability algorithms may be implemented, as described herein.

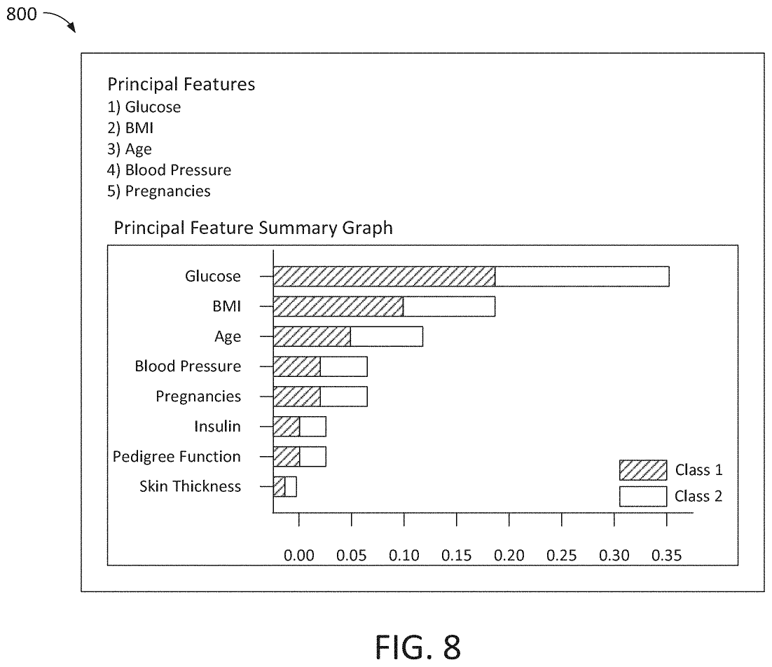

In some examples, the interpretability scores may be provided to a user via, for example, a user interface such as user interface 800 shown in FIG. 8. For example, the user interface 800 displays a listing of data fields most relevant to a binary data field of the dataset used to train the first neural network. For example, the binary data field may be a diabetic status of a subject, where a “1” value indicates that the subject has diabetes and a “0” score indicates that the subject does not have diabetes. As shown in the user interface 800, the interpretability scores may indicate that glucose readings are most indicative of diabetic status, with BMI, age, blood pressure, and number of pregnancies also showing correlation to diabetic status, in order of decreasing strength of predictability. The user interface 800 further includes a principal feature summary graph showing similar information as the principal feature list. That is, the principal feature summary graph displays, in descending order of strength of predictability, features which have predictive value for predicting diabetic status of a subject. The predictability summary graph may show strength of predictive value as correlation values between the features and the binary data field. In various examples, the user interface 800 may include additional information, such as including, in the principal feature summary graph, features that do not have predictive value for predicting the binary data field.

In some examples, after step 306, the trained neural network may be utilized to make various predictions, such as predictions about outcomes for a binary data field of the dataset. For example, where the dataset includes diabetic status as the binary data field, the trained neural network may utilize one or more inputs belonging to the plurality of data fields used to train the neural network to predict whether a patient may have diabetes. For example, a glucose measurement, BMI, age, and blood pressure of the patient may be provided (e.g., via a user interface) to the trained neural network to predict the diabetic status of the patient. In some examples, such predictions may be provided via a user interface and may include an associated confidence score in the prediction.

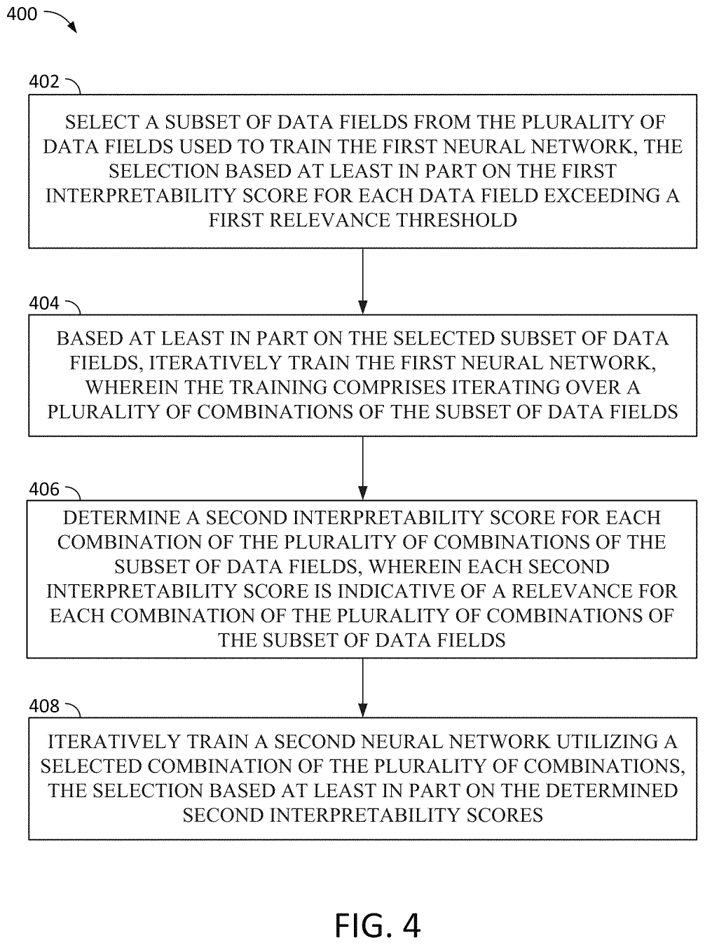

In various examples, the interpretability scores may be used to identify data to train a second neural network as described. For example, data fields with the highest interpretability scores and/or data fields with interpretability scores over a specified threshold (e.g., those having interpretability scores greater than 0), may be provided to a second neural network. The second neural network may then be trained using the identified data to generate predictions about the first data field. In some examples, the second neural network may be trained (e.g., using an optimization algorithm) without iteratively training the second neural network. Additionally or alternatively, the second neural network may be iteratively trained using the identified data as described, for example, with respect to FIG. 4.

Now turning to FIG. 4, FIG. 4 is a flowchart of a method 400 for or generating predictive and optimized neural networks, in accordance with examples described herein. The method 400 may be implemented, for example, using the system 100 of FIG. 1.

The method 400 includes selecting a subset of data fields from the plurality of data fields used to train the first neural network, the selection based at least in part on the first interpretability score for each data field exceeding a first relevance threshold in step 402; based at least in part on the selected subset of data fields, iteratively training the first neural network, wherein the training comprises iterating over a plurality of combinations of the subset of data fields in step 404; determining a second interpretability score for each combination of the plurality of combinations of the subset of data fields, wherein each second interpretability score is indicative of a relevance for each combination of the plurality of combinations of the subset of data fields in step 406; and, iteratively training a second neural network utilizing a selected combination of the plurality of combinations, the selection based at least in part on the determined second interpretability scores in step 408.

Step 402 includes selecting a subset of data fields from the plurality of data fields used to train the first neural network, the selection based at least in part on the first interpretability score for each data field exceeding a first relevance threshold. For example, each data field with an interpretability score over 0 may be selected, as such an interpretability score indicates some relation between the data field and the first data field that the first neural network is trained for. In some examples, the relevance threshold may be dynamically chosen to include, for example, a specified number of data fields. For example, the ten most relevant data fields may be selected, given that the ten most relevant data fields have interpretability scores exceeding 0.

Step 404 includes based at least in part on the selected subset of data fields, iteratively training the first neural network, wherein the training comprises iterating over a plurality of combinations of the subset of data fields.

Step 406 includes determining a second interpretability score for each combination of the plurality of combinations of the subset of data fields, wherein each second interpretability score is indicative of a relevance for each combination of the plurality of combinations of the subset of data fields. The second interpretability score may be determined using one or more interpretability algorithms, as described herein.

Step 408 includes iteratively training a second neural network utilizing a selected combination of the plurality of combinations, the selection based at least in part on the determined second interpretability scores.

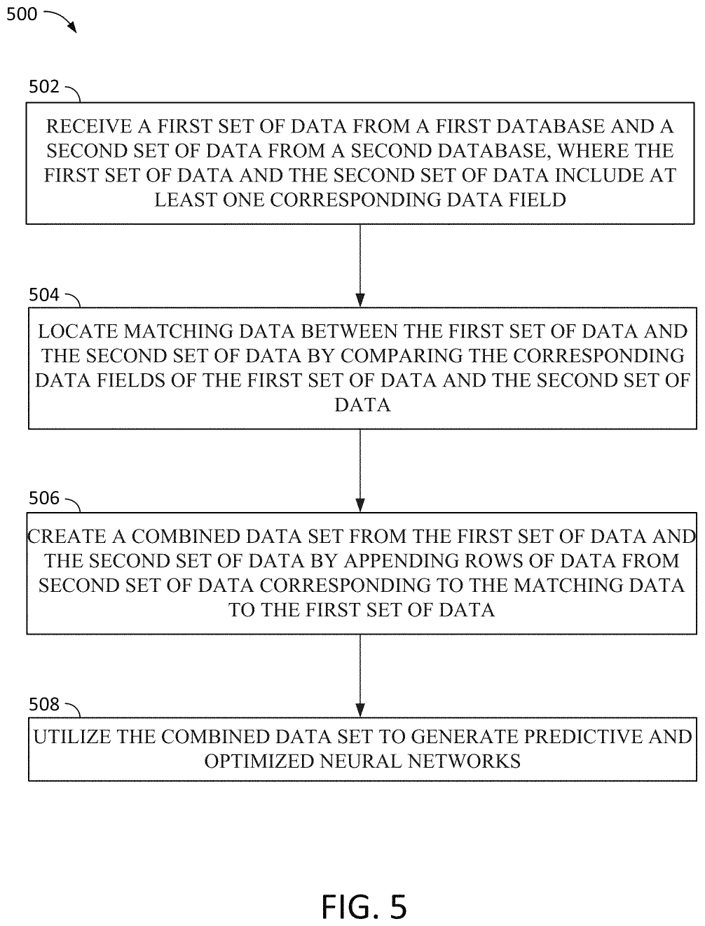

Now turning to FIG. 5, FIG. 5 is a flowchart of a method 500 for combining multiple data sets for generating predictive and optimized neural networks, in accordance with examples described herein. The method 500 may be implemented, for example, using the system 100 of FIG. 1.

The method 500 includes receiving a first set of data from a first database and a second set of data from a second database, where the first set of data and the second set of data include at least one corresponding data field at step 502; locating matching data between the first set of data and the second set of data by comparing the corresponding data fields of the first set of data and the second set of data at step 504; creating a combined data set from the first set of data and the second set of data by appending rows of data from the second set of data corresponding to the matching data to the first set of data at step 506; and utilizing the combined data set to generate predictive and optimized neural networks at step 508.

Step 502 includes receiving a first set of data from a first database and a second set of data from a second database, where the first set of data and the second set of data include at least one corresponding data field. A corresponding data field may be, for example, the same type of data. For example, the first set of data and the second set of data may each include a data field including a patient identifier. In various examples, the same type of data may be, for example, both sets of data containing data fields for ZIP codes, BMI, glucose readings, or other corresponding data fields. As the first set of data and the second set of data may be obtained from different sources, the first set of data and the second set of data may include overlapping rows or columns, more than one corresponding data fields, and the like.

Step 504 includes locating matching data between the first set of data and the second set of data by comparing the corresponding data fields of the first set of data and the second set of data. Matching data may be data where the values of the corresponding data fields are equal. For example, where the corresponding data fields are patient identifiers, a matching numerical identifier may indicate that the data is about the same patient or subject. In some examples, the system may locate matching data by iterating, using each field of the first set of data, over each field of the set of data until matches between the data are found. For example, where a first field of the first set of data is ZIP code, the system may take the first ZIP code value (e.g., 85716) and check for an exact match in each column of the second set of data. Where the first column of the second set of data is age, the system is unlikely to find an exact match. However where a ZIP code column exists, the system may locate another row of data where the ZIP code value is 85716, and identify those values as corresponding data fields.

The system may also, in some examples, locate corresponding data using rules for translating one type of data into another. For example, the first set of data may include ZIP codes and the second set of data may include county of residence. A rule matching ZIP codes to county of residence may be used to translate the ZIP code values into county values, and corresponding data fields may then be identified by iterating over each field of the second set of data until matches between the data are found. In some examples, corresponding data fields may be data fields in the same row in the first set of data and the second set of data. Such rows may be combined in a random way, and relationships identified using feature analysis. In some examples, the system may locate matching data based on units of time. For example, the first set of data and the second set of data may include a time of data collection. Corresponding data may be data having a similar or the same time of collection (e.g., data collected on the same day, within the same hour, within the same minute, etc.)

Step 506 includes creating a combined data set from the first set of data and the second set of data by appending rows of data from the second set of data corresponding to the matching data to the first set of data. For example, where the corresponding data field is a patient identifier and a match is located, indicating that the data is about the same subject, additional data fields present in the second set of data but not in the first set of data may be appended to the first set of data in the row associated with the matching patient identifier. Such a combined data set may provide additional data fields which may, in some examples, be found to be relevant to the binary value for which a neural network is trained. For example, the first data set may include clinical data (e.g., BMI, blood pressure, blood glucose, other laboratory values), while the second data set may include demographic data (e.g., place of residence, marital status, lifestyle habits, and the like) not included in the first data set. Accordingly, the combined data set may provide more data which may be relevant or useful in predicting a binary outcome (e.g., diabetic status or diagnosis of other disease states).

Step 508 includes utilizing the combined data set to generate predictive and optimized neural networks. For example, the combined data set may be used in the methods 300 and/or 400 to generate predictive and optimized neural networks, as well as to identify data fields of the combined data set with relevance and/or predictable value for another field of the data set. By using a combined data set created using the method 500, the neural networks may be trained using additional data, and the data sets may be more robust. For example, the combined data set may include data fields not included in the first data set, but which may also have high predictive value for the first data field. A neural network trained using data fields from both the first data set and the second data set may have a higher predictive value (e.g., accuracy or confidence) than a neural network trained using either the first set of data or the second set of data alone.

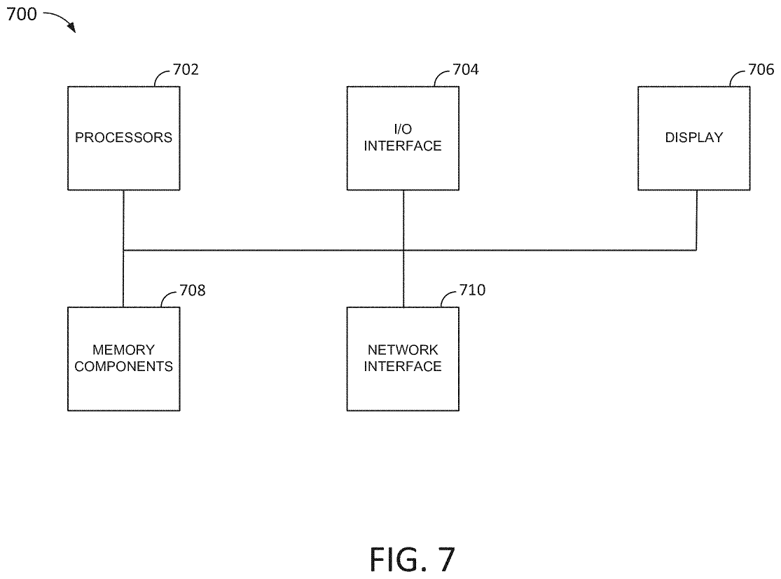

Now turning to FIG. 6, FIG. 6 is an illustration of an interpretability chart 600, in accordance with examples described herein. The interpretability chart 600 may be generated, for example, using computing device 108 of FIG. 1, and may be displayed, for example, using display 706 of FIG. 7.

The interpretability chart 600 generally represents a SHAP value plot 602 associated with SHAP scores for various data fields used to train neural networks as described herein. In some examples, each SHAP value (e.g., score, etc.) for a particular data field (e.g., column field) may be indicative of the average marginal contribution across all permutations of data fields used to train a neural network.

As illustrated, interpretability chart 600 includes SHAP value plot 602, column fields (e.g., features) 604a-604e, and impact key 606. As should be appreciated, in some examples, column fields 604a-604e may be listed (e.g., ranked) in descending order. In some examples, data key 606 may be associated with whether a particular feature's contribution (e.g., column field, variable, etc.) is high or low for a particular observation. In some examples, the horizontal locations of each value within the SHAP value plot 602 may be indicative of whether the effect of that value is associated with a higher or lower prediction.

As one non-limiting example, and as illustrated in interpretability chart 600, column field 1604a content has a high and positive impact of the overall quality rating as correlated with the target variable. In this example, the high comes from the lighter color, and the positive impact is shown on the x-axis. In this example, interpretability chart 600 also illustrates that column field 2 604b is negatively correlated with the target variable.

As should be appreciated, while interpretability chart 600 of FIG. 6 illustrates a SHAP data plot, other types of interpretability charts, reports, plots, and the like are contemplated to be within the scope of this disclosure. In some examples, interpretability chart 600 may be presented on a display such as display 706 of FIG. 7 and/or a user device, such as one of user devices 104a-104c of FIG. 1. In some examples, providing such charts to a user may provide additional (e.g., useful, beneficial, etc.) data field insight during neural network training that may have previously absent from standard neural network training protocols and/or workflows.

Now turning to FIG. 7, FIG. 7 is a schematic diagram of an example computing system 700 for implementing various embodiments in the examples described herein. Computing system 700 may be used to implement the user devices 104a-104c, computing device 108, or it may be integrated into one or more of the components of system 100, such user devices 104a-104c and/or computing device 108. Computing system 700 may be used to implement or execute one or more of the components or operations disclosed in FIGS. 1-6. In FIG. 7, computing system 700 may include one or more processors 702, an input/output (I/O) interface 704, a display 706, one or more memory components 708, and a network interface 710. Each of the various components may be in communication with one another through one or more buses or communication networks, such as wired or wireless networks.

Processors 702 may be implemented using generally any type of electronic device capable of processing, receiving, and/or transmitting instructions. For example, processors 702 may include or be implemented by a central processing unit, microprocessor, processor, microcontroller, or programmable logic components (e.g., FPGAs). Additionally, it should be noted that some components of computing system 700 may be controlled by a first processor and other components may be controlled by a second processor, where the first and second processors may or may not be in communication with each other.

Memory components 708 may be used by computing system 700 to store instructions, such as executable instructions discussed herein, for the processors 702, as well as to store data, such as data described herein, and the like. Memory components 708 may be, for example, magneto-optical storage, read-only memory, random access memory, erasable programmable memory, flash memory, or a combination of one or more types of memory components.

Display 706 provides, in some examples, interpretability score information to a user of computing device 108 of FIG. 1 and/or user devices 104a-104c of FIG. 1. In some examples, display 706 provides interpretability chart information, such as interpretability chart 600 of FIG. 6. Optionally, display 706 may act as an input element to enable a user of computing device 108 to manually alter, review, revise, interpret, and the like the interpretability scores and or charts, or any other component in system 100 as described in the present disclosure. Display 706 may be a liquid crystal display, plasma display, organic light-emitting diode display, and/or other suitable display. In embodiments where display 706 is used as an input, display 706 may include one or more touch or input sensors, such as capacitive touch sensors, a resistive grid, or the like.

The I/O interface 704 allows a user to enter data into the computing system 700, as well as provides an input/output for the computing system 700 to communicate with other devices or services, user devices 104a-104c and/or computing device 108 of FIG. 1. I/O interface 704 can include one or more input buttons, touch pads, track pads, mice, keyboards, audio inputs (e.g., microphones), audio outputs (e.g., speakers), and so on.

Network interface 710 provides communication to and from the computing system 700 to other devices. For example, network interface 710 may allow user devices 104a-104c to communicate with computing device 108 through a communication network, such as network 102 of FIG. 1. Network interface 710 includes one or more communication protocols, such as, but not limited to Wi-Fi, Ethernet, Bluetooth, cellular data networks, and so on. Network interface 710 may also include one or more hardwired components, such as a Universal Serial Bus (USB) cable, or the like. The configuration of network interface 710 depends on the types of communication desired and may be modified to communicate via Wi-Fi, Bluetooth, and so on.

In accordance with the above, systems and methods for generating predictive and optimized neural networks are described. Neural networks generated using the above systems and methods may provide higher predictive value when compared to conventionally trained networks. For example, the systems and methods described herein identify data fields with higher interpretability scores (e.g., predictive value) relative to a particular output variable. Accordingly, a neural network may be trained using input values which are most relevant to the output, creating more accurate neural networks as the networks will be able to predict outcomes based on data that is most likely tied to the causation of such outcomes (rather than, for example, mere correlations that while occur with outcomes are not directly the cause of such outcomes). Such neural networks may then be utilized in a wider variety of applications, including those where accuracy is important. Further, the systems and methods described herein may utilize fewer resources (e.g., processing resources, time to train, and the like) when compared to conventionally trained networks that may be inclined to predict correlated impacts rather than actual true causation for different inputs. For example, by training networks using the data fields having the highest predictive value, training may be more efficient and generation of predictions may be more efficient as the trained neural networks may have fewer variables for which to account. Accordingly, neural networks generated using the systems and methods described herein provide improvements over conventionally trained neural networks.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method comprising:
receiving data from a database, wherein the data is indicative of a first instance of the database, and wherein the data comprises a plurality of data fields;
training a first neural network for a first data field, the training based at least in part on utilizing the plurality of data fields;
determining a first interpretability score for each data field of the plurality of data fields used to train the first neural network, wherein each first interpretability score is indicative of a relevance for each data field of the plurality of data fields used to train the first neural network;
selecting a subset of data fields from the plurality of data fields used to train the first neural network, the selection based at least in part on the first interpretability score for each data field exceeding a first relevance threshold; and
training a second neural network using the selected subset of data fields, the second neural network trained to provide predictions related to the first data field.

2. The method of claim 1, wherein training the first neural network for the first data field comprises iteratively training the first neural network for the first data field.

3. The method of claim 1, further comprising:
based at least in part on the selected subset of data fields, iteratively training the first neural network, wherein the training comprises iterating over a plurality of combinations of the subset of data fields;
determining a second interpretability score for each combination of the plurality of combinations of the subset of data fields, wherein each second interpretability score is indicative of a relevance for each combination of the plurality of combinations of the subset of data fields; and
wherein the second neural network is trained by iteratively training the second neural network utilizing a selected combination of the plurality of combinations, the selection based at least in part on the determined second interpretability scores.

4. The method of claim 3, further comprising:
iteratively training the second neural network further based at least based at least in part on utilizing parameters, hyperparameters, or combinations thereof.

5. The method of claim 4, further comprising:
receiving at the first instance of the database, an input query regarding the plurality of data fields, the query written using Boolean logic; and
based at least in part on receiving the query, utilizing the second trained neural network to determine and transmit an output answer.

6. The method of claim 3, wherein each second interpretability score determined for combination of the plurality of combinations of the subset of data is indicative of the relevance for each combination of the plurality of combinations of the subset of data fields.

7. The method of claim 1, wherein the data fields comprise one or more row fields, one or more column fields, or combinations thereof.

8. The method of claim 1, wherein determining the first interpretability score for each data field of the plurality of data fields used to train the first neural network is based at least in part on utilizing an interpretability algorithm.

9. The method of claim 1, wherein each first interpretability score determined for each data field of the plurality of data fields used to train the first neural network is indicative of the relevance for each data field of the plurality of data fields used to train the first neural network.

10. The method of claim 1, wherein determining the second interpretability score for each combination of the plurality of combinations of the subset of data is based at least in part on utilizing an interpretability algorithm.

11. A non-transitory computer readable storage medium including instructions that, when executed by at least one processor of a computing system, cause the computing system to perform a method comprising:
receiving a first set of data from a first database and a second set of data from a second database, wherein the first set of data and the second set of data include at least one corresponding data field;
locating matching data between the first set of data and the second set of data by comparing the corresponding data fields of the first set of data and the second set of data;
creating a combined data set from the first set of data and the second set of data by appending rows of data from the second set of data corresponding to the matching data of the first set of data, wherein the combined data set includes a plurality of data fields;
training a first neural network for a first data field of a plurality of data fields of the combined set of data, the training based at least in part on utilizing the plurality of data fields;
selecting a subset of data fields from the plurality of data fields used to train the first neural network, based at least in part on determining a first interpretability score for each data field exceeding a first relevance threshold, wherein each first interpretability score is indicative of a relevance for each data field of the plurality of data fields used to train the first neural network; and
training a second neural network using the selected subset of data fields, the second neural network trained to provide predictions related to the first data field.

12. The non-transitory computer readable medium of claim 11, wherein the method further comprises:
based at least in part on the selected subset of data fields, iteratively training the first neural network, wherein the training comprises iterating over a plurality of combinations of the subset of data fields;
determining a second interpretability score for each combination of the plurality of combinations of the subset of data fields, wherein each second interpretability score is indicative of a relevance for each combination of the plurality of combinations of the subset of data fields; and
wherein training the second neural network comprises iteratively training the second neural network utilizing a selected combination of the plurality of combinations, the selection based at least in part on the determined second interpretability scores.

13. The non-transitory computer readable storage medium of claim 12, wherein the method further comprises iteratively training the second neural network further based at least based at least in part on utilizing parameters, hyperparameters, or combinations thereof.

14. The non-transitory computer readable storage medium of claim 13, wherein the method further comprises receiving at the first instance of the database, an input query regarding the plurality of data fields, the query written using Boolean logic, and, based at least in part on receiving the query, utilizing the second trained neural network to determine and transmit an output answer.

15. The non-transitory computer readable storage medium of claim 12, wherein determining the second interpretability score for each combination of the plurality of combinations of the subset of data is based at least in part on utilizing an interpretability algorithm.

16. The non-transitory computer readable storage medium of claim 11, wherein determining the first interpretability score for each data field of the plurality of data fields used to train the first neural network is based at least in part on utilizing an interpretability algorithm.

17. The non-transitory computer readable storage medium of claim 11, wherein each first interpretability score determined for each data field of the plurality of data fields used to train the first neural network is indicative of the relevance for each data field of the plurality of data fields used to train the first neural network.

18. A system comprising:
a datastore comprising one or more instances of a database, wherein a first instance of the database is included in the one or more instances of the database, and wherein the first instance of the database comprises one or more data fields including row fields, column fields, or combinations thereof;
a computing device, in communication with the datastore, and configured to:
receive the first instance of the database,
train a first neural network for a first data field, the training based at least in part on utilizing the one or more of data fields,
determine a first interpretability score for each data field of the one or more of data fields used to train the first neural network, wherein each first interpretability score is indicative of a relevance for each data field of the one or more data fields used to train the first neural network,
select a subset of data fields from the one or more data fields used to train the first neural network, the selection based at least in part on the first interpretability score for each data field exceeding a first relevance threshold,
based at least in part on the selected subset of data fields, train the first neural network, wherein the training comprises iterating over one or more combinations of the subset of data fields,
determine a second interpretability score for each combination of the one or more of combinations of the subset of data fields, wherein each second interpretability score is indicative of a relevance for each combination of the one or more of combinations of the subset of data fields, and
train a second neural network utilizing a selected combination of the one or more of combinations, the selection based at least in part on the determined second interpretability scores; and
a display, communicatively coupled to the computing device, and configured to cause presentation of the first interpretability score, the second interpretability score, or combinations thereof.

19. The system of claim 18, wherein the computing device is further configured to:
receive, at the first instance of the database, an input query regarding the plurality of data fields, the query written using Boolean logic; and
based at least in part on receiving the query, utilizing the second trained neural network to determine and transmit an output answer.

20. The system of claim 18, wherein determining the first interpretability score for each data field of the plurality of data fields used to train the first neural network is based at least in part on utilizing an interpretability algorithm.
